(19) United States
(12) Patent Application Publication
(10) Pub. No.: US 2013/0083897 A1
(43) Pub. Date: Apr. 4, 2013

(54) RADIOGRAPHIC IMAGE DETECTING DEVICE, RADIOGRAPHIC IMAGE DETECTING METHOD, AND COMPUTER-READABLE STORAGE MEDIUM

(71) Applicants: Yasunori OHTA, Kanagawa (JP); Naoyuki NISHINO, Kanagawa (JP)

(72) Inventors: Yasunori OHTA, Kanagawa (JP); Naoyuki NISHINO, Kanagawa (JP)

(73) Assignee: FUJIFILM CORPORATION, Tokyo (JP)

(21) Appl. No.: 13/600,012

(22) Filed: Aug. 30, 2012

(30) Foreign Application Priority Data
Sep. 30, 2011 (JP) 2011-218044

(51) Int. Cl. H05G 1/64

(52) U.S. Cl. 378/91

(57) ABSTRACT

A radiographic image detecting device includes: a radiation detecting panel in which plural radiation detecting elements that generate electric charges in response to a dose of irradiated radiation are two-dimensionally arrayed; plural image acquiring units that read out the electric charges stored in the radiation detecting elements belonging to each of plural blocks into which the plural radiation detecting elements are divided to thereby acquire image data; a power source that supplies power for driving to the image acquiring units corresponding to each of the plural blocks; and a controller that controls in such a way as to cut off the supply of power from the power source to the image acquiring units corresponding to the blocks in accordance with a predetermined condition.

### CROSS-REFERENCE TO RELATED APPLICATION

This application is based on and claims priority under 35 USC 119 from Japanese Patent Application No. 2011-218044 filed on Sep. 30, 2011, the disclosure of which is incorporated by reference herein.

### BACKGROUND

1. Technical Field

The present invention relates to a radiographic image detecting device that captures a radiographic image represented by radiation that has passed through an imaging target site, a radiographic image detecting method, and a computer-readable storage medium.

2. Related Art

In recent years, radiation detectors such as flat panel detectors (FPD), in which a radiation-sensitive layer is placed on a thin-film transistor (TFT) active matrix substrate and which can directly convert radiation into digital data, have been put into practical use. Furthermore, radiographic image capturing devices that use these radiation detectors to capture radiographic images expressed by irradiated radiation have also been put into practical use. The methods by which the radiation detectors used in these radiographic image capturing devices convert the radiation include the indirect conversion method, in which the radiation is first converted into light by means of a scintillator and then the light is converted into electric charge by means of a semiconductor layer such as a photodiode, and the direct conversion method, in which the radiation is converted into electric charge by means of a semiconductor layer such as amorphous selenium. In each method, there exist a variety of materials that can be used for the semiconductor layer.

Incidentally, in this type of radiographic image capturing device, as long as the radiographic image capturing device itself can detect when the irradiation of the radiation starts and stops and the radiation dose, it becomes unnecessary to interconnect the radiation source and the imaging controller that controls en bloc the radiographic image capturing device and the radiation source. Therefore, this simplifies the system configuration and simplifies the control by the imaging controller, which is preferred.

On the other hand, it is necessary for portable radiographic image capturing devices to be equipped with a drive power source, and it is common for portable radiographic image capturing devices to be placed in a standby mode in cases where the radiographic image capturing device switches between and uses an internal power source and an external power source in accordance with operating conditions, for example, or where the radiographic image capturing device will not be used for a certain amount of time. For example, Japanese Patent Application Laid-Open (JP-A) No. 2006-208305 discloses a radiographic image detector that can switch between and use an internal power source and an external power source. In this radiographic image detector, when imaging ends, power supply with respect to a signal read-out circuit is stopped (placed in a standby mode) to control power consumption, because power consumption is greater in the signal read-out circuit than in other configural members.

Further, JP-A No. 2010-212925 discloses a portable radiographic image capturing device that takes as a target only a region of regions of radiation detecting components that is used for radiographic imaging and in which the irradiation of the radiation has been detected by means of current flowing in a bias line of a radiation detecting region and performs image data read-out processing, image data storage processing, and image data transmission processing. By doing so, the portable radiographic image capturing device increases the efficiency of radiographic imaging and shortens the image data transmission time.

The radiographic image detector of JP-A No. 2006-208305 stops, and places in an imaging standby mode, the power supply to the signal read-out circuit. Further, the portable radiographic image capturing device of JP-A No. 2010-212925 switches between a power supply mode and a standby mode by performing different processing in regions in which the irradiation of the radiation has been detected and regions in which the irradiation of the radiation is not detected due to their relationship to the imaging site of the radiographic image. The technologies in both documents have the problem that power saving is insufficient because they stop the power supply in the standby mode.

### SUMMARY

The present invention has been made in view of the above-described problem, and it is an object thereof to realize power saving in a radiographic image detecting device with a simple method.

A radiographic image detecting device pertaining to a first aspect of the present invention includes: a radiation detecting panel in which plural radiation detecting elements that generate electric charges in response to a dose of irradiated radiation are two-dimensionally arrayed; plural image acquiring units that read out the electric charges stored in the radiation detecting elements belonging to each of plural blocks into which the plural radiation detecting elements are divided to thereby acquire image data; a power source that supplies power for driving to the image acquiring units corresponding to each of the plural blocks; and a controller that controls in such a way as to cut off the supply of power from the power source to the image acquiring units corresponding to the blocks in accordance with a predetermined condition.

According to a radiographic image detecting device pertaining to a second aspect, the radiographic image detecting device further includes a radiation detecting unit that detects a region of the radiation detecting panel to which the radiation is not irradiated, wherein the controller takes as a condition the irradiation of the radiation not being detected by the radiation detecting unit and controls in such a way as to cut off the supply of power from the power source to the image acquiring unit belonging to the block corresponding to the region in which the irradiation of the radiation is not detected.

Further, according to a radiographic image detecting device pertaining to a third aspect, the radiographic image detecting device further includes a battery remaining capacity detecting unit that detects the battery remaining capacity of a battery installed in the radiographic image detecting device, wherein the controller takes as a condition the battery remaining capacity detected by the battery remaining capacity detecting unit, decreases a target range of the plural image acquiring units to which the power supply is cut off as the battery remaining capacity becomes higher and enlarges the target range of the plural image acquiring units to which the power supply is cut off as the battery remaining capacity becomes lower.

Further, according to a radiographic image detecting device pertaining to a fourth aspect, the controller enlarges the region of the blocks that detect the irradiated radiation by decreasing the target range of the plural image acquiring units to which the power supply is cut off and reduces the region of the blocks that detect the irradiated radiation by enlarging the target range of the plural image acquiring units to which the power supply is cut off.

According to a radiographic image detecting device pertaining to a fifth aspect, the radiographic image detecting device further includes a presenting unit that presents the region of the blocks to which the supply of the power has been cut off.

Further, a radiographic image detecting device pertaining to a sixth aspect further includes a comparing unit that compares the region of the blocks corresponding to the image acquiring units to which the power source has been supplied and a region required for imaging an imaging target site of a radiographic image and a notifying unit that issues a predetermined notification in a case where the region of the blocks is smaller than the region required for imaging.

In a radiographic image detecting device pertaining to a seventh aspect, the radiation detecting elements have semiconductor films that receive the irradiation of the radiation and generate electric charges, the electric charges are stored in storage capacitors disposed in each of the plural pixels, and the electric charges that have been stored in the storage capacitors are read out by the switch elements.

Further, in a radiographic image detecting device pertaining to an eighth aspect, the radiation detecting elements have a scintillator that converts the irradiated radiation into visible light, and after the visible light into which the irradiated radiation has been converted is converted into electric charges in a semiconductor layer, electric signals corresponding to the electric charges are outputted by the switch elements.

Further, a radiographic image detecting method pertaining to a ninth aspect of the present invention includes: dividing, into plural blocks, plural radiation detecting elements that are two-dimensionally arrayed in a radiation detecting panel and generate electric charges in response to a dose of irradiated radiation and reading out, with image acquiring units, the electric charges stored in the radiation detecting elements belonging to each of the plural blocks to thereby acquire image data; supplying power for driving to the image acquiring units corresponding to each of the plural blocks; detecting a region of the radiation detecting panel to which the radiation is not irradiated; and controlling in such a way as to cut off the supply of power from the power source to the image acquiring units belonging to the blocks corresponding to the region in which irradiation of the radiation is not detected.

A computer-readable storage medium pertaining to a tenth aspect of the present invention stores a program that causes a radiographic image detecting device to execute processing, the radiographic image detecting device including a radiation detecting panel in which plural radiation detecting elements that generate electric charges in response to a dose of irradiated radiation are two-dimensionally arrayed, plural image acquiring units that read out the electric charges stored in the radiation detecting elements belonging to each of plural blocks into which the plural radiation detecting elements are divided to thereby acquire image data, and a power source that supplies power for driving to the image acquiring units corresponding to each of the plural blocks, the processing including: detecting whether or not the radiation is irradiated to the radiation detecting panel, and controlling in such a way as to cut off the supply of power from the power source with respect to the blocks corresponding to a region in which irradiation of the radiation is not detected by the radiation detecting unit.

According to the present invention, the supply of power from the power source to an image reading unit corresponding to a block in regard to a region in which the irradiation of the radiation to the radiation detecting panel is not detected by the radiation detecting unit is cut off, so power consumption can be controlled with a simple configuration.

### BRIEF DESCRIPTION OF THE DRAWINGS

Exemplary embodiments of the present invention will be described in detail based on the following figures, wherein:

FIG. 1 is a diagram showing the schematic configuration of a radiographic image capturing system pertaining to a first embodiment of the present invention;

FIG. 2 is a cross-sectional schematic view schematically showing the configuration of pixel sections of a radiation detector built into an electronic cassette pertaining to the first embodiment;

FIG. 3 is a cross-sectional view showing the configuration of a signal output portion in the radiation detector of the electronic cassette pertaining to the first embodiment;

FIG. 4 is a plan view showing the configuration of the radiation detector of the electronic cassette pertaining to the first embodiment;

FIG. 5 is a plan view showing the configuration of the radiation detector pertaining to the first embodiment;

FIG. 6 is a perspective view showing the configuration of the electronic cassette pertaining to the first embodiment;

FIG. 7 is a block diagram showing the configuration of the radiographic image capturing system including the configurations of relevant portions of an electrical system of the electronic cassette;

FIG. 8 is a circuit diagram showing the configuration of an image generating unit pertaining to the first embodiment;

FIG. 9 is a circuit diagram showing the configuration of a radiation irradiation detecting unit pertaining to the first embodiment;

FIG. 10 is a flowchart showing a flow of radiographic image capturing processing pertaining to the first embodiment;

FIG. 11 is a flowchart showing a processing sequence in the electronic cassette of the radiographic image capturing system pertaining to the first embodiment;

FIG. 12 is a block diagram showing the configurations of relevant portions of an electrical system of an electronic cassette pertaining to a second embodiment;

FIG. 13 is a flowchart showing a flow of region enlargement/reduction processing based on battery remaining capacity in the electronic cassette pertaining to the second embodiment; and

FIG. 14 is a flowchart showing a processing sequence in a third embodiment.

### DETAILED DESCRIPTION

### First Embodiment

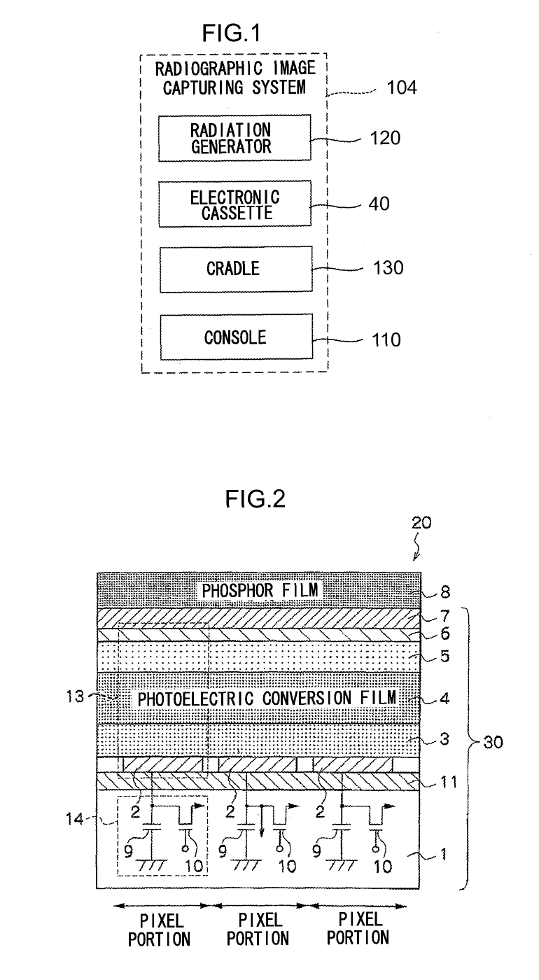

Modes for implementing the present invention will be described in detail below with reference to the drawings. FIG. 1 shows the schematic configuration of a radiographic image capturing system 104 pertaining to a first embodiment of the present invention. The radiographic image capturing system 104 accepts imaging requests from unillustrated terminal devices and captures radiographic images as a result of being operated by a doctor or a radiologic technologist in accordance with an instruction from a server that manages a radiographic imaging schedule. The radiographic image capturing system 104 is equipped with a radiation generator 120, an electronic cassette 40, a cradle 130, and a console 110. The radiation generator 120 applies a dose of radiation X according to exposure conditions from a radiation source to a subject. The electronic cassette 40 has a built-in radiation detector 20 that absorbs the radiation X that has passed through an imaging target site of the subject, generates electric charges, and creates image data representing a radiographic image on the basis of the generated electric charge quantity. The cradle 130 charges a battery built into the electronic cassette 40. The console 110 controls the electronic cassette 40 and the radiation generator 120.

When the electronic cassette 40 is not in use, the electronic cassette 40 is stored in an accommodating portion of the cradle 130, and the built-in battery of the electronic cassette 40 is charged by the cradle 130. When a radiographic image is to be captured, the electronic cassette 40 is removed from the cradle 130 by a radiologic technologist, for example. The electronic cassette 40 is held in a holder of a standing position stand if the imaging posture is a standing position or is held in a holder of a lying position table if the imaging posture is a lying position. In the radiographic image capturing system 104, various types of data are transmitted and received by wireless communication between the radiation generator 120 and the console 110 and between the electronic cassette 40 and the console 110.

The electronic cassette 40 is not just used only in a state in which it is held in the holder of the standing position stand or the holder of the lying position table; rather, because the electronic cassette 40 is portable, it can also be used in a state in which it is not being held in a holder when imaging arms or legs, for example.

FIG. 2 is a cross-sectional schematic view schematically showing the configuration of pixel sections of the radiation detector 20 built into the electronic cassette 40 of the radiographic image capturing system 104 pertaining to the first embodiment of the present invention. As shown in FIG. 2, in the radiation detector 20 pertaining to the present embodiment, signal output portions 14, sensor portions 13, and a scintillator 8 are sequentially layered on an insulating substrate 1. Pixels are configured by the signal output portions 14 and the sensor portions 13. The pixels are plurally arrayed on the substrate 1 and are configured in such a way that the signal output portion 14 and the sensor portion 13 in each pixel are on top of one another.

The scintillator 8 is formed via a transparent insulating film 7 on the sensor portions 13. The scintillator 8 comprises a phosphor film that converts radiation made incident thereon from above (the opposite side of the substrate 1 side) or below into light and emits light. By disposing the scintillator 8, the radiation that has passed through the subject is absorbed and light is emitted. It is preferred that the wavelength range of the light emitted by the scintillator 8 be in the visible light range (a wavelength of 360 nm to 830 nm). It is more preferred that the wavelength range of the light that the scintillator 8 emits include the green wavelength range in order to enable monochrome imaging by the radiation detector 20.

As the phosphor used for the scintillator 8, specifically a phosphor including cesium iodide (CsI) is preferred in the case of imaging using X-rays as the radiation. Using CsI(Tl) (cesium iodide to which thallium has been added) whose emission spectrum when X-rays are irradiated is 400 nm to 700 nm is particularly preferred. The emission peak wavelength in the visible light range of CsI(Tl) is 565 nm.

The sensor portions 13 have an upper electrode 6, lower electrodes 2, and a photoelectric conversion film 4 that is placed between the upper electrode 6 and the lower electrodes 2. The photoelectric conversion film 4 is configured by an organic photoelectric conversion material that absorbs the light emitted by the scintillator 8 and generates an electric charge. It is preferred that the upper electrode 6 be configured by a conducting material that is transparent at least with respect to the emission wavelength of the scintillator 8 because it is necessary to allow the light produced by the scintillator 8 to be made incident on the photoelectric conversion film 4. More specifically, using a transparent conducting oxide (TCO) whose transmittance with respect to visible light is high and whose resistance value is small for the upper electrode 6 is preferred. A metal thin film of Au or the like can also be used as the upper electrode 6, but its resistance value tends to increase when trying to obtain a transmittance of 90% or more, so a TCO is more preferred. For example, ITO, IZO, AZO, FTO, SnO₂, TiO₂, ZnO₂, etc. can be preferably used. ITO is most preferred from the standpoints of process ease, low resistance, and transparency. The upper electrode 6 may have a single configuration shared by all the pixels or may be divided per pixel.

The photoelectric conversion film 4 includes the organic photoelectric conversion material, absorbs the light emitted from the scintillator 8, and generates an electric charge corresponding to the absorbed light. The photoelectric conversion film 4 including the organic photoelectric conversion material in this way has a sharp absorption spectrum in the visible range, absorbs virtually no electromagnetic waves other than the light emitted by the scintillator 8, and can effectively suppress noise generated as a result of radiation such as X-rays being absorbed by the photoelectric conversion film 4.

It is preferred that the absorption peak wavelength of the organic photoelectric conversion material configuring the photoelectric conversion film 4 be as close as possible to the emission peak wavelength of the scintillator 8 so that the organic photoelectric conversion material most efficiently absorbs the light emitted by the scintillator 8. It is ideal that the absorption peak wavelength of the organic photoelectric conversion material and the emission peak wavelength of the scintillator 8 coincide, but as long as the difference between them is small, the organic photoelectric conversion material can sufficiently absorb the light emitted from the scintillator 8. Specifically, it is preferred that the difference between the absorption peak wavelength of the organic photoelectric conversion material and the emission peak wavelength of the scintillator 8 with respect to radiation be within 10 nm. It is more preferred that the difference be within 5 nm.

Examples of organic photoelectric conversion materials that can satisfy this condition include quinacridone organic compounds and phthalocyanine organic compounds. For example, the absorption peak wavelength in the visible range of quinacridone is 560 nm, so if quinacridone is used as the organic photoelectric conversion material and CsI(Tl) is used as the material of the scintillator 8, it becomes possible to keep the difference between the peak wavelengths within 5 nm and the quantity of electric charge generated in the photoelectric conversion film 4 can be substantially maximized.

Next, the photoelectric conversion film 4 applicable to the radiation detector 20 pertaining to the present embodiment will be specifically described. The electromagnetic wave absorption/photoelectric conversion site in the radiation detector 20 pertaining to the present embodiment can be configured by the pair of electrodes 2 and 6 and an organic layer that includes the photoelectric conversion film 4 sandwiched between the electrodes 2 and 6. More specifically, the organic layer can be formed by stacking or mixing together a site that absorbs electromagnetic waves, a photoelectric conversion site, an electron-transporting site, a hole-transporting site, an electron-blocking site, a hole-blocking site, a crystallization preventing site, electrodes, an interlayer contact improving site, etc. It is preferred that the organic layer include an organic p-type compound or an organic n-type compound.

Organic p-type semiconductors (compounds) are donor organic semiconductors (compounds) represented mainly by hole-transporting organic compounds and refer to organic compounds having the property that they easily donate electrons. More specifically, organic p-type semiconductors (compounds) refer to organic compounds whose ionization potential is the smaller of the two when two organic materials are brought into contact with each other and used. Consequently, any organic compound can be used as the donor organic compound provided that it is an electron-donating organic compound.

Organic n-type semiconductors (compounds) are accepter organic semiconductors (compounds) represented mainly by electron-transporting organic compounds and refer to organic compounds having the property that they easily accept electrons. More specifically, organic n-type semiconductors (compounds) refer to organic compounds whose electron affinity is the greater of the two when two organic compounds are brought into contact with each other and used. Consequently, any organic compound can be used as the accepter organic compound provided that it is an electron-accepting organic compound.

Materials applicable as the organic p-type semiconductor and the organic n-type semiconductor, and the configuration of the photoelectric conversion film 4, are described in detail in JP-A No. 2009-32854, so description thereof will be omitted here. The photoelectric conversion film 4 may also be formed so as to further include fullerenes or carbon nanotubes.

It is preferred that the film thickness of the photoelectric conversion film 4 be as large as possible in terms of absorbing the light from the scintillator 8. However, if the film thickness of the photoelectric conversion film 4 becomes thicker than a certain extent, the strength of the electric field generated in the photoelectric conversion film 4 by the bias voltage applied from both ends of the photoelectric conversion film 4 drops and the electric charge becomes unable to be collected. For this reason, it is preferred that the film thickness of the photoelectric conversion film 4 be from 30 nm to 300 nm. It is more preferred that the film thickness of the photoelectric conversion film 4 be from 50 nm to 250 nm. It is particularly preferred that the film thickness of the photoelectric conversion film 4 be from 80 nm to 200 nm. In the radiation detector 20 shown in FIG. 2, the photoelectric conversion film 4 has a single configuration shared by all the pixels, but the photoelectric conversion film 4 may also be divided per pixel.

The lower electrodes 2 are a thin film that has been divided per pixel. The lower electrodes 2 can be configured by a transparent or opaque conducting material, and aluminum, silver, etc. can be suitably used. The thickness of the lower electrodes 2 can be from 30 nm to 300 nm, for example.

In the sensor portions 13, one from the electric charge (holes, electrons) generated in the photoelectric conversion film 4 can be moved to the upper electrode 6 and the other can be moved to the lower electrodes 2 by applying a predetermined bias voltage between the upper electrode 6 and the lower electrodes 2. In the radiation detector 20, a wire is connected to the upper electrode 6, and the bias voltage is applied to the upper electrode 6 via this wire. Further, the polarity of the bias voltage is decided in such a way that the electrons generated in the photoelectric conversion film 4 move to the upper electrode 6 and the holes move to the lower electrodes 2, but this polarity may also be the opposite.

It suffices for the sensor portions 13 configuring each of the pixels to include at least the lower electrodes 2, the photoelectric conversion film 4, and the upper electrode 6. However, in order to suppress an increase in dark current, disposing at least either of an electron-blocking film 3 and a hole-blocking film 5 is preferred, and disposing both is more preferred. The electron-blocking film 3 can be disposed between the lower electrodes 2 and the photoelectric conversion film 4. The electron-blocking film 3 can suppress electrons from being injected from the lower electrodes 2 into the photoelectric conversion film 4 and dark current from ending up increasing when the bias voltage has been applied between the lower electrodes 2 and the upper electrode 6. Electron-donating organic materials can be used for the electron-blocking film 3.

It suffices for the material that is actually used for the electron-blocking film 3 to be selected in accordance with, for example, the material of the adjacent electrodes and the material of the adjacent photoelectric conversion film 4. A material whose electron affinity (Ea) is greater by 1.3 eV or more than the work function (Wf) of the material of the adjacent electrodes and has an ionization potential (Ip) equal to or smaller than the ionization potential of the material of the adjacent photoelectric conversion film 4 is preferred. Materials applicable as the electron-donating organic material are described in detail in JP-A No. 2009-32854, so description thereof will be omitted here.

In order to allow the electron-blocking film 3 to reliably exhibit a dark current suppressing effect and to prevent a drop in the photoelectric conversion efficiency of the sensor portions 13, it is preferred that the thickness of the electron-blocking film 3 be from 10 nm to 200 nm. It is more preferred that the thickness of the electron-blocking film 3 be from 30 nm to 150 nm. It is particularly preferred that the thickness of the electron-blocking film 3 be from 50 nm to 100 nm.

The hole-blocking film 5 can be disposed between the photoelectric conversion film 4 and the upper electrode 6. The hole-blocking film 5 can suppress holes from being injected from the upper electrode 6 into the photoelectric conversion film 4 and dark current from ending up increasing when the bias voltage has been applied between the lower electrodes 2 and the upper electrode 6. Electron-accepting organic materials can be used for the hole-blocking film 5. In order to allow the hole-blocking film 5 to reliably exhibit a dark current suppressing effect and to prevent a drop in the photoelectric conversion efficiency of the sensor portions 13, it is preferred that the thickness of the hole-blocking film 5 be from 10 nm to 200 nm. It is more preferred that the thickness of the hole-blocking film 5 be from 30 nm to 150 nm. It is particularly preferred that the thickness of the hole-blocking film 5 be from 50 nm to 100 nm.

It suffices for the material that is actually used for the hole-blocking film 5 to be selected in accordance with, for example, the material of the adjacent electrode and the material of the adjacent photoelectric conversion film 4. A material whose ionization potential (Ip) is greater by 1.3 eV or more than the work function (Wf) of the material of the adjacent electrode and has an electron affinity (Ea) equal to or greater than the electron affinity of the material of the adjacent photoelectric conversion film 4 is preferred. Materials applicable as the electron-accepting organic material are described in detail in JP-A No. 2009-32854, so description thereof will be omitted here.

In a case where the bias voltage is set in such a way that, from the electric charge generated in the photoelectric conversion film 4, the holes move to the upper electrode 6 and the electrons move to the lower electrode 2, it suffices to reverse the positions of the electron-blocking film 3 and the hole-blocking film 5. Further, the electron-blocking film 3 and the hole-blocking film 5 do not both have to be disposed; a certain degree of a dark current suppressing effect can be obtained as long as either is disposed.

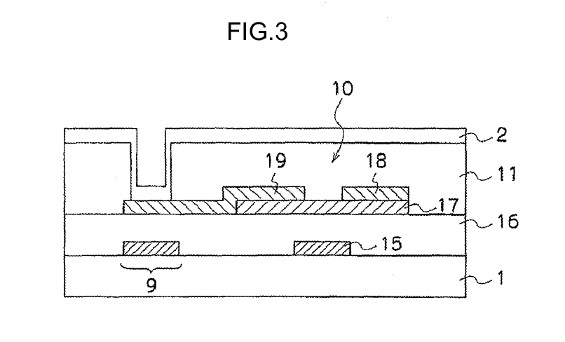

FIG. 3 schematically shows the configuration of the signal output portions 14 formed on the surface of the substrate 1 below the lower electrodes 2 of each of the pixels. As shown in FIG. 3, in each of the signal output portions 14, a capacitor 9 and a field-effect thin-film transistor (TFT) (hereinafter this will also be simply called a “thin-film transistor”) 10 are formed in correspondence to the lower electrode 2. The capacitor 9 stores the electric charge that has moved to the lower electrode 2. The thin-film transistor 10 converts the electric charge stored in the capacitor 9 into an electric signal and outputs the electric signal. The region in which the capacitor 9 and the thin-film transistor 10 are formed has a section that coincides with the lower electrode 2 in a plan view. By giving the signal output portion 14 this kind of configuration, the signal output portion 14 and the sensor portion 13 in each of the pixels come to be on top of one another in the thickness direction. In order to minimize the plane area of the radiation detector 20 (the pixels), it is preferred that the region in which the capacitor 9 and the thin-film transistor 10 are formed be completely covered by the lower electrode 2.

The capacitor 9 is electrically connected to the corresponding lower electrode 2 via a wire of a conducting material that is formed penetrating an insulating film 11 disposed between the substrate 1 and the lower electrode 2. Because of this, the electric charge trapped in the lower electrode 2 can be moved to the capacitor 9.

In the thin-film transistor 10, a gate electrode 15, a gate insulating film 16, and an active layer (channel layer) 17 are layered. Moreover, a source electrode 18 and a drain electrode 19 are formed a predetermined spacing apart from each other on the active layer 17. The active layer 17 can, for example, be formed by amorphous silicon, an amorphous oxide, an organic semiconductor material, carbon nanotubes, etc. The material configuring the active layer 17 is not limited to these.

In a case where the active layer 17 is configured by an amorphous oxide, oxides including at least one of In, Ga, and Zn (e.g., In—O amorphous oxides) are preferred, oxides including at least two of In, Ga, and Zn (e.g., In—Zn—O amorphous oxides, In—Ga—O amorphous oxides, or Ga—Zn—O amorphous oxides) are more preferred, and oxides including In, Ga, and Zn are particularly preferred. As an In—Ga—Zn—O amorphous oxide, an amorphous oxide whose composition in a crystalline state is expressed by InGaO₃(ZnO)ₘ (where m is a natural number less than 6) is preferred, and particularly InGaZnO₄ is more preferred.

Examples of organic semiconductor materials capable of configuring the active layer 17 include phthalocyanine compounds, pentacene, and vanadyl phthalocyanine, but the organic semiconductor materials are not limited to these. Configurations of phthalocyanine compounds are described in detail in JP-A No. 2009-212389, so description thereof will be omitted here.

By forming the active layer 17 of the thin-film transistor 10 from an amorphous oxide, an organic semiconductor material, or carbon nanotubes, the active layer 17 does not absorb radiation such as X-rays, or if it does absorb any radiation the amount absorbed is only an extremely minute amount, so the generation of noise in the signal output portion 14 can be effectively suppressed.

Further, in a case where the active layer 17 is formed with carbon nanotubes, the switching speed of the thin-film transistor 10 can be increased, and the thin-film transistor 10 can be formed having a low degree of absorption of light in the visible light range. In the case of forming the active layer 17 with carbon nanotubes, the performance of the thin-film transistor 10 drops significantly just if an infinitesimal amount of a metal impurity is mixed into the active layer 17, so it is necessary to separate, extract, and form extremely high-purity carbon nanotubes by centrifugal separation or the like.

Here, the amorphous oxide, organic semiconductor material, or carbon nanotubes configuring the active layer 17 of the thin-film transistor 10 and the organic photoelectric conversion material configuring the photoelectric conversion film 4 are all capable of being formed into films at a low temperature. Consequently, the substrate 1 is not limited to a substrate with high heat resistance, such as a semiconductor substrate, a quartz substrate, or a glass substrate, and a plastic or other flexible substrate, aramids, or bionanofibers can also be used. Specifically, polyester, such as polyethylene terephthalate, polybutylene phthalate, and polyethylene naphthalate, polystyrene, polycarbonate, polyethersulphone, polyarylate, polyimide, polycyclic olefin, norbornene resin, and poly(chloro-trifluoro-ethylene) or other flexible substrates can be used. By employing a flexible substrate made of plastic, the substrate can be made lightweight, which becomes advantageous for portability, for example.

Further, an insulating layer for ensuring insulation, a gas barrier layer for preventing the transmission of moisture and oxygen, an undercoat layer for improving flatness or adhesion to the electrodes or the like, and other layers may also be disposed on the substrate 1.

High-temperature processes reaching 200 degrees or higher can be applied to aramids, so a transparent electrode material can be hardened at a high temperature and given a low resistance, and aramids can also handle automatic packaging of driver ICs including solder reflow processes. Further, aramids have a thermal expansion coefficient that is close to that of indium tin oxide (ITO) or a glass substrate, so they have little warping after manufacture and do not break easily. Further, aramids can also form a thinner substrate compared to a glass substrate or the like. An ultrathin glass substrate and an aramid may also be layered to form a substrate.

Further, bionanofibers are composites of cellulose microfibril bundles (bacterial cellulose) that a bacterium (Acetobacter xylinum) produces and a transparent resin. Cellulose microfibril bundles have a width of 50 nm, which is a size that is 1/10 with respect to visible wavelengths, and have high strength, high elasticity, and low thermal expansion. By impregnating and hardening a transparent resin such as an acrylic resin or an epoxy resin in bacterial cellulose, bionanofibers exhibiting a light transmittance of about 90% at a wavelength of 500 nm while including fibers at 60 to 70% can be obtained. Bionanofibers have a low thermal expansion coefficient (3 to 7 ppm) comparable to silicon crystal, a strength comparable to steel (460 MPa), high elasticity (30 GPa), and are flexible, so they can form a thinner substrate 1 compared to a glass substrate or the like.

In the present embodiment, a TFT substrate 30 is formed by sequentially forming the signal output portions 14, the sensor portions 13, and the transparent insulating film 7 on the substrate 1, and the radiation detector 20 is formed by adhering the scintillator 8 onto the TFT substrate 30 using, for example, an adhesive resin whose light absorbance is low.

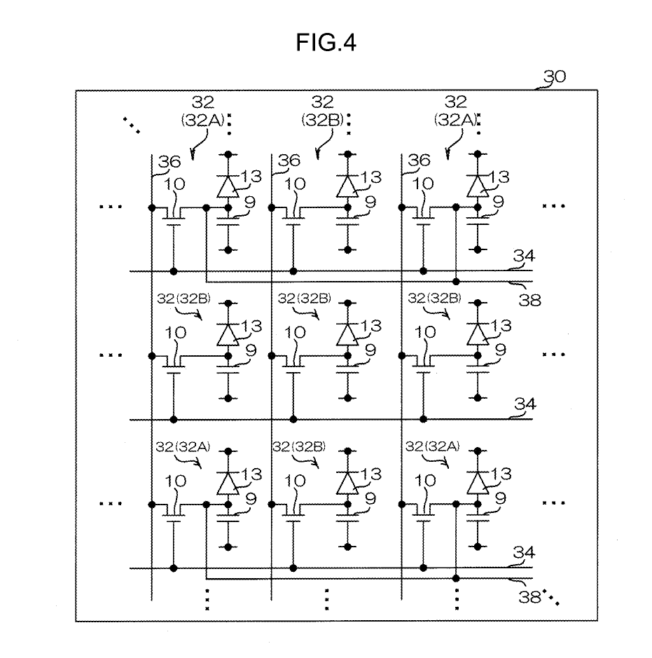

FIG. 4 is a plan view showing the configuration of the radiation detector 20 of the electronic cassette 40 pertaining to the present embodiment. As shown in FIG. 4, on the TFT substrate 30, pixels 32 configured to include the sensor portions 13, the capacitors 9, and the thin-film transistors 10 are plurally disposed two-dimensionally in one direction (a row direction in FIG. 4) and an intersecting direction (a column direction in FIG. 4) with respect to the one direction.

Further, plural gate lines 34 that are disposed extending in the one direction (the row direction) and are for switching on and off the thin-film transistors 10 and plural data lines 36 (signal lines) that are disposed extending in the intersecting direction (the column direction) and are for reading out the electric charges via the thin-film transistors 10 in an on-state are disposed in the radiation detector 20. The radiation detector 20 is formed in a tabular, quadrilateral shape having four sides on its outer edges in a plan view; more specifically, the radiation detector 20 is formed in a rectangular shape.

Here, in the radiation detector 20, some of the pixels 32 are used to detect the state of irradiation in each of radiation detection regions divided into plural blocks as described later, and the remaining pixels 32 capture radiographic images. Hereinafter, the pixels 32 for detecting the state of irradiation will be called radiation detecting pixels 32A (radiation detecting elements) and the remaining pixels 32 will be called radiographic image acquiring pixels 32B.

The radiation detector 20 cannot obtain pixel data of radiographic images in the positions in which the radiation detecting pixels 32A are placed because the radiation detector 20 captures radiographic images with the radiographic image acquiring pixels 32B excluding the radiation detecting pixels 32A of the pixels 32. For this reason, in the radiation detector 20, the radiation detecting pixels 32A are placed in such a way as to be dispersed and the console 110 executes defective pixel correction processing created by interpolating the pixel data of the radiographic image in the positions in which the radiation detecting pixels 32A are placed using pixel data that has been obtained by the radiographic image acquiring pixels 32B positioned around those radiation detecting pixels 32A.

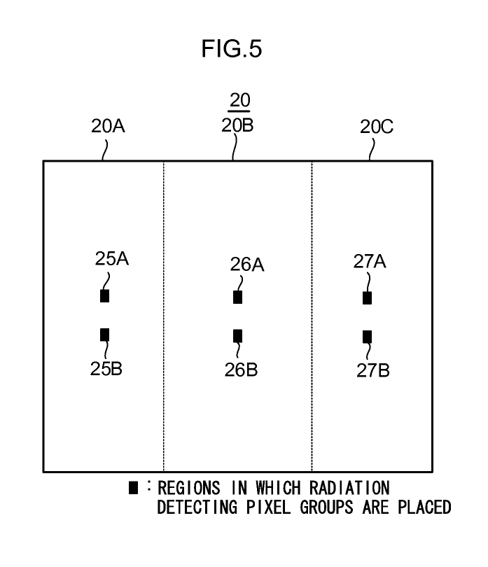

Here, in the radiographic image capturing system 104 pertaining to the present embodiment, there are cases where the radiographic image capturing system 104 performs imaging using the entire imaging region resulting from the radiation detector 20, such as in a case where the imaging target site is the abdomen, for example, and cases where the radiographic image capturing system 104 performs imaging using only part of the imaging region resulting from the radiation detector 20, such as in a case where the imaging target side is a leg, an arm, or a hand, for example. Further, in the radiation detector 20, for example, as schematically shown in FIG. 5, the imaging region is divided in rectangular strip shapes into plural blocks and the radiation detecting pixels 32A are placed in imaging regions 20A, 20B, and 20C. Specifically, the pixels 32A are placed in regions 25A and 25B in the neighborhood of the center portion of the imaging region 20A, in regions 26A and 26B in the neighborhood of the center portion of the imaging region 20B, and in regions 27A and 27B in the neighborhood of the center portion of the imaging region 20C.

Here, the imaging region is divided into three blocks, but the number of blocks into which the imaging region is divided is not limited to this. Further, the areas of the individual blocks may be the same or different. The shapes into which the imaging region is divided are also not limited to rectangular strip shapes. For example, the imaging region may be divided into a grid or may be divided by lines having angles with respect to the end portions of the radiation detector 20. Moreover, the imaging region may be divided by shapes in which plural rectangles with different areas are placed concentrically about the center of the imaging region.

Additionally, in order to detect the state of irradiation, in the radiation detector 20, as shown in FIG. 4, direct read-out lines 38 (radiation detecting lines), to which connecting portions between the capacitors 9 and the thin-film transistors 10 in the radiation detecting pixels 32A are connected and which are for directly reading out the electric charges stored in those capacitors 9, are disposed extending in the one direction (the row direction). In the radiation detector 20, one direct read-out line 38 is allocated with respect to plural radiation detecting pixels 32A lined up in the one direction, and the connecting portions between the capacitors 9 and the thin-film transistors 10 in those plural radiation detecting pixels 32A are connected to a shared (single) direct read-out line 38.

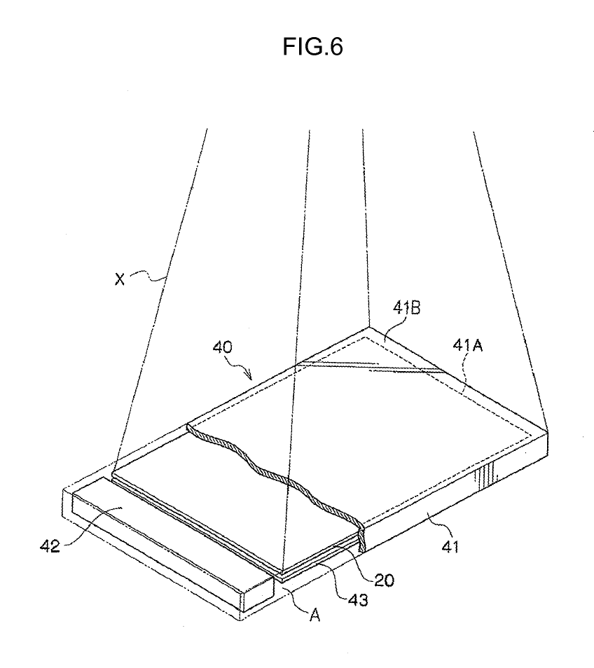

Next, the configuration of the electronic cassette 40 pertaining to the present embodiment will be described. FIG. 6 is a perspective view showing the configuration of the electronic cassette 40 pertaining to the present embodiment. As shown in FIG. 6, the electronic cassette 40 pertaining to the present embodiment is equipped with a casing 41 made of a material that allows radiation to pass through it, and the electronic cassette 40 is given a waterproof and airtight structure. When the electronic cassette 40 is used in an operating room or the like, there is the concern that blood or other contaminants may adhere to the electronic cassette 40. Therefore, by giving the electronic cassette 40 a waterproof and airtight structure, and disinfecting and cleaning the electronic cassette 40 as needed, one electronic cassette 40 can be used repeatedly.

A space A that accommodates a variety of parts is formed inside the casing 41. The radiation detector 20, which detects the radiation X that has passed through the subject, and a lead plate 43, which absorbs backscattered rays of the radiation X, are disposed in this order inside the space A from an irradiated surface side of the casing 41 to which the radiation X is irradiated.

Here, in the electronic cassette 40, the region corresponding to the disposed position of the radiation detector 20 in one surface of the tabular shape of the casing 41 is configured as a quadrilateral imaging region 41A that is capable of detecting the radiation. The surface having the imaging region 41A of the casing 41 is configured as a top plate 41B of the electronic cassette 40. In the electronic cassette 40 pertaining to the present embodiment, the radiation detector 20 is placed in such a way that the TFT substrate 30 is on the top plate 41B side, and the radiation detector 20 is adhered to the inside surface of the top plate 41B (the surface of the top plate 41B on the opposite side of the surface on which the radiation is made incident) in the casing 41.

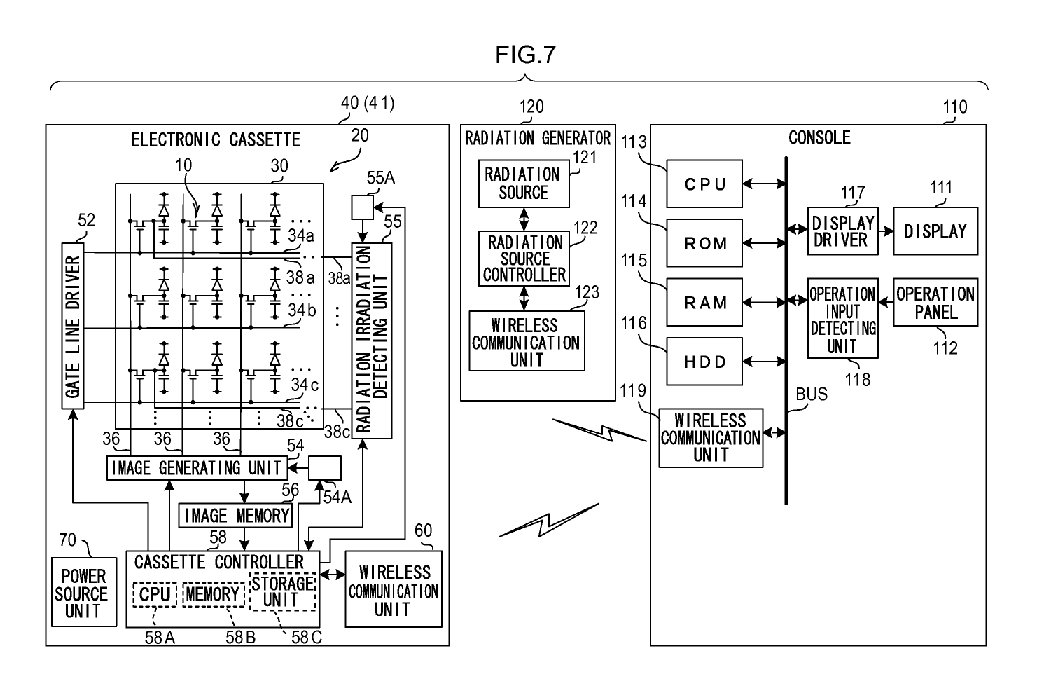

A case 42 that accommodates a later-described cassette controller 58 and a later-described power source unit 70 (see FIG. 7 for both) is placed on one end of the inside of the casing 41 in a position that does not coincide with the radiation detector 20 (outside the range of the imaging region 41A). The casing 41 is configured by carbon fiber, aluminum, magnesium, bionanofibers (cellulose microfibrils), or a composite material, for example, in order to make the entire electronic cassette 40 lightweight.

As the composite material, for example, a material including reinforced fiber resin is used, and carbon, cellulose, or the like is included in the reinforced fiber resin. Specifically, as the composite material, carbon fiber reinforced plastic (CFRP), a composite material with a structure where a foam material is sandwiched by CFRP, or a composite material where the surface of a foam material is coated with CFRP is used. In the present embodiment, a composite material with a structure where a foam material is sandwiched by CFRP is used. Because of this, the strength (rigidity) of the casing 41 can be raised compared to a case where the casing 41 is configured by carbon alone.

Next, the configurations of relevant portions of an electrical system of the radiographic image capturing system 104 pertaining to the present embodiment will be described. FIG. 7 is a block diagram showing the configuration of the radiographic image capturing system 104 including the configurations of relevant portions of an electrical system of the electronic cassette 40. As shown in FIG. 7, in the radiation detector 20 built into the electronic cassette 40, a gate line driver 52 is placed on one side of two sides adjacent to each other, and an image generating unit 54 is placed on the other side. The individual gate lines 34 (in FIG. 7, these are individually indicated as gate lines 34a, 34b, . . . , and these reference signs will be used as needed) of the TFT substrate 30 are connected to the gate line driver 52, and the individual data lines 36 of the TFT substrate 30 are connected to the image generating unit 54. Further, an image memory 56, a cassette controller 58, and a wireless communication unit 60 are disposed inside the casing 41.

The thin-film transistors 10 of the TFT substrate 30 are sequentially switched on in row units by signals supplied via the gate lines 34 from the gate line driver 52, and the electric charges that have been read out by the thin-film transistors 10 switched to an on-state are transmitted through the data lines 36 as electric signals and are input to the image generating unit 54. Because of this, the electric charges are sequentially read out in row units, and a two-dimensional radiographic image becomes acquirable.

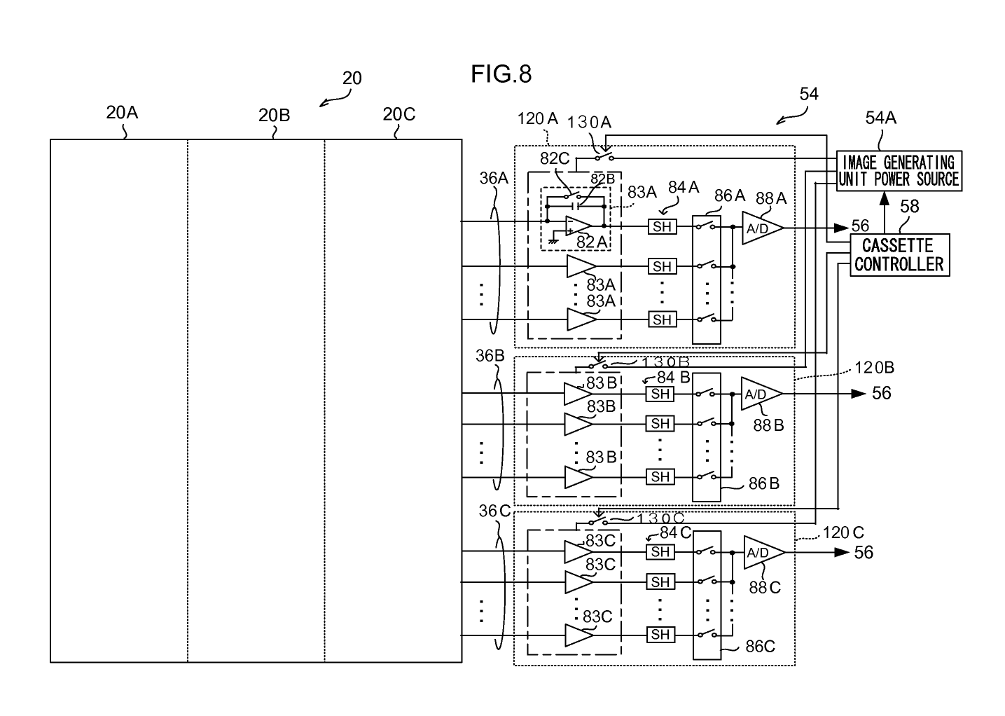

Here, the configuration of the image generating unit 54 will be described. FIG. 8 is a circuit diagram showing the configuration of the image generating unit 54 pertaining to the present embodiment. As shown in FIG. 8, the image generating unit 54 is equipped, in correspondence to each of the imaging regions 20A, 20B, and 20C, with data lines 36A, 36B, and 36C for reading out the electric charge signals from the pixels placed in the imaging regions 20A, 20B, and 20C resulting from the imaging region of the radiation detector 20 being divided into three blocks, variable gain pre-amps (charge amps, first amps) 83A, 83B, and 83C, and sample-and-hold circuits 84A, 84B, and 84C. Each of the variable gain pre-amps 83A, 83B, and 83C is configured to include an op-amp 82A whose positive input (non-inverting electrode) side is grounded, a capacitor 82B that is connected in parallel between the negative input (inverting electrode) side and the output side of the op-amp 82A, and a reset switch 82C. The reset switches 82C are switched by the cassette controller 58.

Further, the image generating unit 54 pertaining to the present embodiment is equipped with multiplexers 86A, 86B, and 86C and analog-to-digital (A/D) converters 88A, 88B, and 88C in correspondence to each of the imaging regions 20A, 20B, and 20C. The sample timings of the sample-and-hold circuits 84A, 84B, and 84C and the select outputs resulting from switches disposed in the multiplexers 86A, 86B, and 86C are also switched by the cassette controller 58.

The electronic cassette 40 is equipped with an image generating unit power source 54A that supplies power for driving to the image generating unit 54. The image generating unit power source 54A is configured by a DC-DC converter whose power input end is connected to a later-described power source unit 70. The output ends of the DC-DC converter are connected to the variable gain pre-amps 83A, 83B, and 83C, the sample-and-hold circuits 84A, 84B, and 84C, the multiplexers 86A, 86B, and 86C, and the A/D converters 88A, 88B, and 88C of the image generating unit 54.

Moreover, the cassette controller 58 is connected to the control input end of the image generating unit power source 54A pertaining to the present embodiment. Additionally, the cassette controller 58 controls the start of the power supply and the stop of the power supply from the image generating unit power source 54A via switches 130A, 130B, and 130C with respect to image reading units 120A, 120B, and 120C that correspond to each of the imaging regions 20A, 20B, and 20C and serve as imaging reading units equipped with the above-described variable gain pre-amps, sample-and-hold circuits, multiplexers, and A/D converters.

When detecting a radiographic image, the cassette controller 58 first switches the reset switches 82C of the variable gain pre-amps 83A, 83B, and 83C to an on-state for a predetermined duration to thereby discharge the electric charges that had been stored in the capacitors 82B. The electric charges stored in the capacitors 9 of the radiographic image acquiring pixels 32B as a result of the radiation X being irradiated are transmitted through the connected data lines 36A, 36B, and 36C as electric signals as a result of the connected thin-film transistors 10 being switched to an on-state, and the electric signals that have been transmitted through the data lines 36A, 36B, and 36C are amplified at a predetermined gain by the corresponding variable gain pre-amps 83A, 83B, and 83C.

After performing the discharge, the cassette controller 58 drives the sample-and-hold circuits 84A, 84B, and 84C for a predetermined duration to thereby cause the sample-and-hold circuits 84A, 84B, and 84C to hold the signal levels of the electric signals amplified by the variable gain pre-amps 83A, 83B, and 83C.

Additionally, the signal levels held in the sample-and-hold circuits 84A, 84B, and 84C are sequentially selected by the multiplexers 86A, 86B, and 86C in accordance with the control by the cassette controller 58 and are converted from analog to digital by the A/D converters 88A, 88B, and 88C, whereby image data representing the captured radiographic image are created.

The image memory 56 is connected to the image generating unit 54. The image data outputted from the A/D converters 88A, 88B, and 88C of the image generating unit 54 are sequentially stored in the image memory 56. The image memory 56 has a storage capacity that is capable of storing a predetermined number of frames' worth of image data. Each time radiographic imaging is performed, the image data obtained by the imaging are sequentially stored in the image memory 56.

The image memory 56 is also connected to the cassette controller 58. The cassette controller 58 is configured to include a microcomputer, is equipped with a central processing unit (CPU) 58A, a memory 58B including a read-only memory (ROM) and a random access memory (RAM), and a nonvolatile storage unit 58C including a flash memory or the like, and controls the actions of the entire electronic cassette 40.

Moreover, the wireless communication unit 60 is connected to the cassette controller 58. The wireless communication unit 60 is adapted to a wireless local area network (LAN) standard represented by IEEE (Institute of Electrical and Electronics Engineers) 802.11a/b/g/n or the like and controls the transmission of various types of data between the electronic cassette 40 and external devices by wireless communication. Via the wireless communication unit 60, the cassette controller 58 is made capable of wireless communication with external devices such as the console 110 that performs control relating to radiographic imaging and is made capable of transmitting and receiving various types of data to and from the console 110 and the like.

Further, a power source unit 70 is disposed in the electronic cassette 40. The various circuits and elements described above (the gate line driver 52, the image generating unit 54, the image memory 56, the wireless communication unit 60, the microcomputer functioning as the cassette controller 58, etc.) are actuated by power supplied from the power source unit 70. The power source unit 70 has a built-in battery (a rechargeable secondary battery) so as to not impair the portability of the electronic cassette 40, and the power source unit 70 supplies power to the various circuits and elements from the charged battery. In FIG. 7, illustration of wires connecting the various circuits and elements to the power source unit 70 is omitted.

In the radiation detector 20 pertaining to the present embodiment, a radiation irradiation detecting unit 55 is placed on the opposite side of the gate line driver 52 across the TFT substrate 30 in order to detect the state of irradiation. The individual direct read-out lines 38 (in FIG. 7, these are individually indicated as direct read-out lines 38a, 38c, . . . , and these reference signs will be used as needed) of the TFT substrate 30 are connected to the radiation irradiation detecting unit 55.

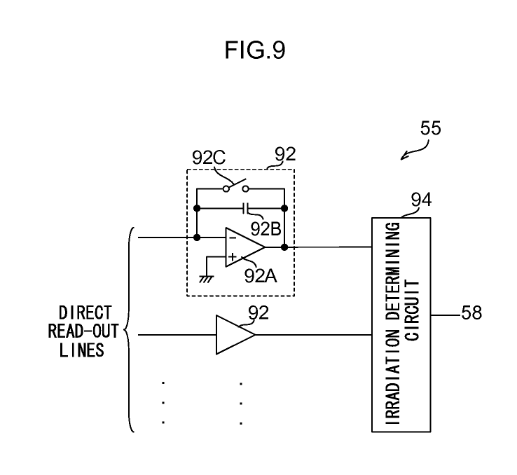

Here, the configuration of the radiation irradiation detecting unit 55 pertaining to the present embodiment will be described. FIG. 9 is a circuit diagram showing the configuration of the radiation irradiation detecting unit 55 pertaining to the present embodiment. As shown in FIG. 9, the radiation irradiation detecting unit 55 is equipped with variable gain pre-amps (charge amps) 92 (second amps) in correspondence to each of the direct read-out lines 38 connected to the radiation detecting pixels 32A. Each of the variable gain pre-amps 92 is configured to include an op-amp 92A whose positive input side is grounded, a capacitor 92B that is connected in parallel between the negative input side and the output side of the op-amp 92A, and a reset switch 92C. The reset switches 92C are switched by the cassette controller 58. Further, the radiation irradiation detecting unit 55 is equipped with an irradiation determining circuit 94 whose input ends are connected to the output ends of the variable gain pre-amps 92 and whose output end is connected to the cassette controller 58.

When detecting the state of irradiation, the cassette controller 58 first switches the reset switches 92C of the variable gain pre-amps 92 to an on-state for a predetermined duration to thereby discharge the electric charges that had been stored in the capacitors 92B. The electric charges stored in the capacitors 9 of the radiation detecting pixels 32A as a result of the radiation X being irradiated are transmitted through the connected direct read-out lines 38 as electric signals, and the electric signals that have been transmitted through the direct read-out lines 38 are amplified at a predetermined gain by the corresponding variable gain pre-amps 92 and are thereafter input to the irradiation determining circuit 94.

The irradiation determining circuit 94 pertaining to the present embodiment determines, on the basis of the electric signals input from the variable gain pre-amps 92, whether or not irradiation of the radiation has been started by acquiring the dose of the radiation X (hereinafter called “radiation dose”) that has been emitted from a radiation source 121 and determining whether or not the radiation dose has reached a predetermined first threshold value. The irradiation determining circuit 94 outputs first determination result data indicating the determination result to the cassette controller 58.

Further, the irradiation determining circuit 94 pertaining to the present embodiment determines whether or not irradiation of the radiation has been ended by determining whether or not the radiation dose has become less than a predetermined second threshold value. The irradiation determining circuit 94 outputs second determination result data indicating the determination result to the cassette controller 58.

When the irradiation determining circuit 94 pertaining to the present embodiment determines whether or not irradiation of the radiation has been started, the irradiation determining circuit 94 controls in such a way as to output data indicating that irradiation of the radiation has been started as the first determination result data in a case where there exist, in the output signals from all the variable gain pre-amps 92 corresponding to the radiation detecting pixels 32A of the imaging regions 20A, 20B, and 20C, output signals in which the radiation dose represented by those output signals has reached the first threshold value.

Further, when the irradiation determining circuit 94 pertaining to the present embodiment determines whether or not irradiation of the radiation has been ended, the irradiation determining circuit 94 controls in such a way as to output data indicating that irradiation of the radiation has been ended as the second determination result data in a case where there exist, in the output signals from all the variable gain pre-amps 92 corresponding to the radiation detecting pixels 32A of the imaging regions 20A, 20B, and 20C, output signals in which the radiation dose represented by those output signals has become less than the second threshold value.

The electronic cassette 40 pertaining to the present embodiment is equipped with a radiation irradiation detecting unit power source 55A that supplies power for driving to the radiation irradiation detecting unit 55. The radiation irradiation detecting unit power source 55A pertaining to the present embodiment is configured by a DC-DC converter whose power input end is connected to the power source unit 70. The output ends of the DC-DC converter are connected to the variable gain pre-amps 92 and the irradiation determining circuit 94 of the radiation irradiation detecting unit 55.

Here, the cassette controller 58 is connected to the control input end of the radiation irradiation detecting unit power source 55A pertaining to the present embodiment. The start of the power supply and the stop of the power supply from the radiation irradiation detecting unit power source 55A are controlled by the cassette controller 58.

As shown in FIG. 7, the console 110 is configured as a server computer and is equipped with a display 111, which displays operation menus, captured radiographic images, and so forth, and an operation panel 112, which is configured to include plural keys and by which various types of data and operation instructions are input.

The console 110 is also equipped with a CPU 113 that controls the actions of the entire device, a ROM 114 in which various programs including a control program are stored beforehand, a RAM 115 that temporarily stores various types of data, a hard disk drive (HDD) 116 that stores and holds various types of data, a display driver 117 that controls the display of various types of data on the display 111, and an operation input detecting unit 118 that detects states of operation with respect to the operation panel 112. Further, the console 110 is equipped with a wireless communication unit 119 that transmits and receives various types of data such as later-described exposure conditions to and from the radiation generator 120 by wireless communication and also transmits and receives various types of data such as image data to and from the electronic cassette 40 by wireless communication.

The CPU 113, the ROM 114, the RAM 115, the HDD 116, the display driver 117, the operation input detecting unit 118, and the wireless communication unit 119 are connected to each other via a system bus. Consequently, the CPU 113 can access the ROM 114, the RAM 115, and the HDD 116, can control the display of various types of data on the display 111 via the display driver 117, and can control the transmission and reception of various types of data to and from the radiation generator 120 and the electronic cassette 40 via the wireless communication unit 119. Further, the CPU 113 can grasp states of operation by a user with respect to the operation panel 112 via the operation input detecting unit 118.

The radiation generator 120 is equipped with the radiation source 121, a wireless communication unit 123 that transmits and receives various types of data such as the exposure conditions to and from the console 110, and a radiation source controller 122 that controls the radiation source 121 on the basis of the received exposure conditions. The radiation source controller 122 is also configured to include a microcomputer and stores the received exposure conditions and so forth. The exposure conditions received from the console 110 include data such as tube voltage, tube current, and so forth. The radiation source controller 122 causes the radiation source 121 to apply the radiation X on the basis of the received exposure conditions. At this time, the radiation source controller 122 sometimes also focuses the radiation X in accordance with the imaging conditions such as the size of the subject.

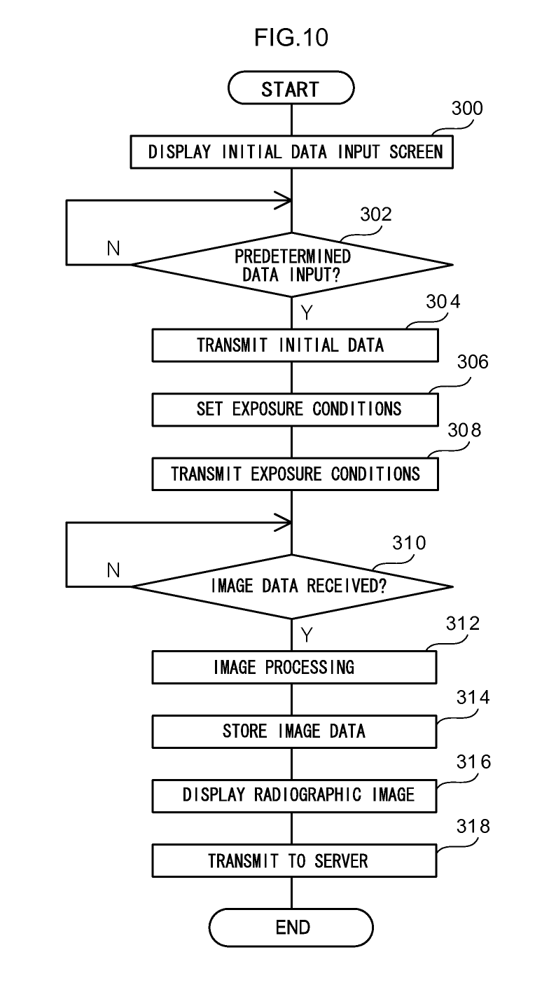

Next, the actions of the radiographic image capturing system 104 pertaining to the present embodiment will be described. First, the actions of the console 110 when capturing a radiographic image will be described with reference to FIG. 10. FIG. 10 is a flowchart showing a flow of processing by a radiographic image capturing processing program that is executed by the CPU 113 of the console 110 when an instruction to execute the program has been input via the operation panel 112. This program is stored beforehand in a predetermined region of the ROM 114.

In step 300 of FIG. 10, the console 110 controls the display driver 117 so as to cause the display 111 to display a predetermined initial data input screen. In the next step 302, the console 110 waits for the input of predetermined data. A radiographer designates, via the operation panel 112, the end button displayed in the neighborhood of the lower end of the initial data input screen. When the end button is designated, the console 110 moves to step 304. In step 304, the console 110 transmits the data that has been input in the initial data input screen (hereinafter, this data will be called “initial data”) to the electronic cassette 40 via the wireless communication unit 119. In the next step 306, the console 110 sets the exposure conditions by transmitting the exposure conditions included in the initial data to the radiation generator 120 via the wireless communication unit 119. In response to this, the radiation source controller 122 of the radiation generator 120 prepares for exposure in the received exposure conditions.

In the next step 308, the console 110 transmits instruction data instructing the start of exposure to the radiation generator 120 via the wireless communication unit 119. In response to this, the radiation source 121 starts emitting the radiation X at the tube voltage, the tube current, and the duration of exposure corresponding to the exposure conditions that the radiation generator 120 received from the console 110. The radiation X emitted from the radiation source 121 passes through the subject and thereafter reaches the electronic cassette 40.

When the cassette controller 58 of the electronic cassette 40 receives the initial data, the cassette controller 58 stands by until the first determination result data being outputted from the irradiation determining circuit 94 becomes data indicating that irradiation of the radiation has been started. Thereafter, the cassette controller 58 starts the action of capturing the radiographic image. Next, the electronic cassette 40 stands by until the second determination result data being outputted from the irradiation determining circuit 94 becomes data indicating that irradiation of the radiation has been ended. Thereafter, the electronic cassette 40 ends the imaging action. Then, when the electronic cassette 40 ends the action of capturing the radiographic image, the electronic cassette 40 transmits the image data obtained by the imaging to the console 110.

In the next step 310, the console 110 stands by until the image data are received from the electronic cassette 40. In the next step 312, the console 110 administers the defective pixel correction processing with respect to the received image data and thereafter executes image processing that performs various types of correction such as shading correction. In the next step 314, the console 110 stores in the HDD 116 the image data on which the image processing has been performed (hereinafter called “corrected image data”). In the next step 316, the console 110 controls the display driver 117 so as to cause the display 111 to display the radiographic image represented by the corrected image data for checking and so forth. Then, in step 318, the console 110 transmits the corrected image data to an unillustrated server via an in-hospital network. Thereafter, the console 110 ends the radiographic image capturing processing program. The corrected image data that have been transmitted to the server are stored in a database so that it becomes possible for doctors to read the captured radiographic image and make a diagnosis.

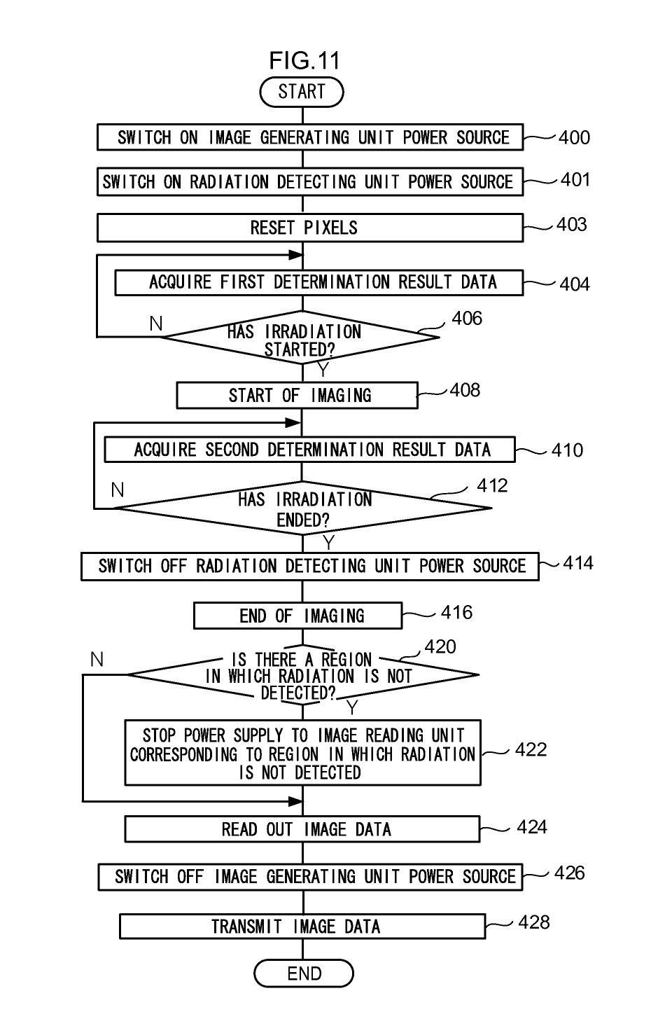

FIG. 11 is a flowchart showing a processing sequence in the electronic cassette 40 of the radiographic image capturing system 104. FIG. 11 is a flowchart showing a flow of processing by a cassette imaging processing program that is executed by the CPU 58A in the cassette controller 58 of the electronic cassette 40 when it has received the initial data from the console 110. This program is stored beforehand in a predetermined region of the memory 58B.

In step 400 of FIG. 11, the cassette controller 58 controls the image generating unit power source 54A so as to start the power supply from the image generating unit power source 54A to the image generating unit 54. Thereafter, in the next step 401, the cassette controller 58 controls the radiation irradiation detecting unit power source 55A so as to start the power supply from the radiation irradiation detecting unit power source 55A to the radiation irradiation detecting unit 55. In the next step 403, the cassette controller 58 controls the gate line driver 52, causes on-signals to be outputted sequentially one line at a time from the gate line driver 52 to the gate lines 34a, 34b, 34c, . . . , and discharges the electric charges stored in the capacitors 9 in the pixels 32 of the radiation detector 20 to thereby reset the pixels 32 including the radiation detecting pixels 32A and the radiographic image acquiring pixels 32B. The action of resetting the pixels 32 that is performed by the processing of step 403 may be performed just one time or may be repeated plural times.

In the next step 404, the cassette controller 58 acquires the first determination result data from the irradiation determining circuit 94. In the next step 406, the cassette controller 58 determines whether or not the acquired first determination result data is data indicating that irradiation of the radiation has been started. If the first determination result data indicates that irradiation of the radiation has been started, the cassette controller 58 moves to the processing of step 408. In step 408, the cassette controller 58 starts the action of capturing the radiographic image by initiating the storage of electric charges in the capacitors 9 in the pixels 32 of the radiation detector 20.

In the next step 410, the cassette controller 58 acquires the second determination result data from the irradiation determining circuit 94. In the next step 412, the cassette controller 58 determines whether or not the acquired second determination result data is data indicating that irradiation of the radiation has been ended. If the second determination result data indicates that irradiation has been ended, the cassette controller 58 moves to the processing of step 414. In step 414, the cassette controller 58 controls the radiation irradiation detecting unit power source 55A so as to stop the power supply from the radiation irradiation detecting unit power source 55A to the radiation irradiation detecting unit 55 that was started by the processing of step 400. In the next step 416, the cassette controller 58 ends the imaging action that was started by the processing of step 408.

In step 420, the cassette controller 58 acquires, by means of the irradiation determining circuit 94, the applied dose of radiation in each of the imaging regions 20A, 20B, and 20C into which the imaging region is divided in rectangular strip shapes into three blocks. Additionally, the cassette controller 58 determines whether or not there is, among the imaging regions 20A, 20B, and 20C, a region in which the radiation could not be detected. If there is, among the imaging regions 20A, 20B, and 20C, a region in which the radiation could not be detected, in the next step 422 the cassette controller 58 stops the power supply from the image generating unit power source 54A to the image reading unit among the image reading units 120A, 120B, and 120C shown in FIG. 8 corresponding to the region in which the radiation could not be detected. Specifically, the cassette controller 58 switches off the switch among the switches 130A, 130B, and 130C in FIG. 8 that supplies power to the image reading unit corresponding to the region in which the radiation was not detected to thereby stop the power supply to that image reading unit.

On the other hand, because power is being supplied to the image reading units corresponding to the regions of the imaging regions 20A, 20B, and 20C in which the radiation was able to be detected, in step 424 the cassette controller 58 reads out the image data in the image reading units corresponding to the regions in which the radiation was detected. That is, the cassette controller 58 controls the gate line driver 52 in regard to the imaging regions in which the radiation was detected, causes on-signals to be outputted sequentially one line at a time from the gate line driver 52 to the gate lines 34a, 34b, 34c, . . . , and sequentially switches on one line at a time the thin-film transistors 10 connected to the gate lines 34. In the radiation detector 20, when the thin-film transistors 10 connected to the gate lines 34 are sequentially switched on one line at a time, the electric charges stored in the capacitors 9 sequentially flow out one line at a time as electric signals to the data lines 36. The electric signals flowing out to the data lines 36 are converted into digital image data by the image generating unit 54, and the image data are stored in the image memory 56.

In the next step 426, the cassette controller 58 discharges the electric charges in which dark current was stored and residual electric charges after the read-out of the electric charges in the capacitors 9 in the pixels 32 of the radiation detector 20 has ended to thereby reset the pixels 32 including the radiation detecting pixels 32A and the radiographic image acquiring pixels 32B. Further, the cassette controller 58 controls the image generating unit power source 54A so as to stop the power supply from the image generating unit power source 54A to the image generating unit 54. Then, in the next step 428, the cassette controller 58 reads out the image data stored in the image memory 56 and transmits the image data it has read out to the console 110 via the wireless communication unit 60. Thereafter, the cassette controller 58 ends the cassette imaging processing program.

In a case where the radiation detector 20 is configured as a so-called back surface reading type (ISS: Irradiation Side Sampling) in which the radiation is applied from the side on which the scintillator 8 of FIG. 2 is formed and the radiographic image is read by the TFT substrate 30 disposed on the back surface side of the surface on which the radiation is made incident, light is emitted more strongly on the upper surface side of the scintillator 8 (the opposite side of the TFT substrate 30 side). In a case where the radiation detector 20 is configured as a so-called front surface reading type (PSS: Penetration Side Sampling) in which the radiation is applied from the TFT substrate 30 side and the radiographic image is read by the TFT substrate 30 disposed on the front surface side of the surface on which the radiation is made incident, the radiation that has passed through the TFT substrate 30 is made incident on the scintillator 8, and the TFT substrate 30 side of the scintillator 8 more strongly emits light. In the sensor portions 13 disposed on the TFT substrate 30, electric charges are generated by the light generated by the scintillator 8. For this reason, the emission position of the scintillator 8 with respect to the TFT substrate 30 is closer in a case where the radiation detector 20 is configured as a front surface reading type than in a case where the radiation detector 20 is configured as a back surface reading type, so the resolution of the radiographic image obtained by imaging is higher.

Further, in the radiation detector 20, the photoelectric conversion film 4 is configured by an organic photoelectric conversion material, and virtually no radiation is absorbed by the photoelectric conversion film 4. For this reason, in the radiation detector 20 pertaining to the present embodiment, the amount of radiation absorbed by the photoelectric conversion film 4 is small even in a case where the radiation passes through the TFT substrate 30 because of the front surface reading type, so a drop in sensitivity with respect to the radiation can be suppressed. In the front surface reading type, the radiation passes through the TFT substrate 30 and reaches the scintillator 8, but in a case where the photoelectric conversion film 4 of the TFT substrate 30 is configured by an organic photoelectric conversion material in this way, there is virtually no absorption of the radiation by the photoelectric conversion film 4 and attenuation of the radiation can be kept small, so configuring the photoelectric conversion film 4 with an organic photoelectric conversion material is suited to the front surface reading type.

Further, the amorphous oxide configuring the active layers 17 of the thin-film transistors 10 and the organic photoelectric conversion material configuring the photoelectric conversion film 4 are both capable of being formed into films at a low temperature. For this reason, the substrate 1 can be formed by plastic resin, aramid, or bionanofibers in which there is little absorption of radiation. In the substrate 1 formed in this way, the amount of radiation absorbed is small, so a drop in sensitivity with respect to the radiation can be suppressed even in a case where the radiation passes through the TFT substrate 30 because of the front surface reading type.

As described in detail above, in the present embodiment, the radiation detecting region (imaging region) is divided into plural blocks, the state of irradiation (irradiation dose) in each of the blocks is detected, and, if there is a region in which the radiation could not be detected, control is performed in such a way as to cut off the power supply to the image reading unit corresponding to the block in regard to that region. By doing so, in the radiation detector, the control and management of the power consumption in the image reading units (image generating unit) including the variable gain pre-amps (charge amps) whose power consumption is large can be performed in block units, and power saving in the entire electronic cassette also becomes possible. That is, power saving can be achieved by cutting off, with a simple configuration, the power supply to the image reading unit corresponding to the pixel block to which the radiation is not irradiated and which does not contribute to the formation of the radiographic image.

Further, the plural pixels disposed for detecting the radiation are used as sensor portions to determine whether or not the radiation has been irradiated in each of the divided detecting regions, so a configuration for saving power can be realized with a simple circuit.

### Second Embodiment

In the first embodiment, there was described an embodiment in the case of saving power in a radiation detector by cutting off the power supply to the image reading unit corresponding to the region, in the imaging region of the radiation detector 20 divided into plural blocks, in which the irradiated radiation could not be detected. Here, as a second embodiment, there will be described a configuration that enlarges the imaging region on the basis of the remaining capacity of the battery built into the radiation detector.

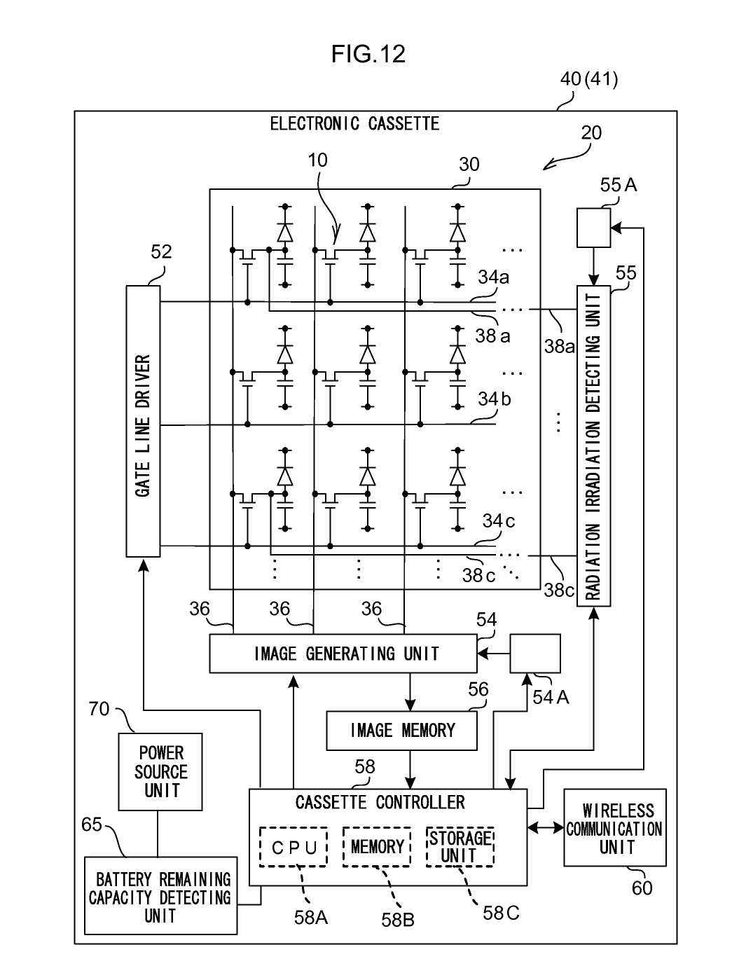

FIG. 12 is a block diagram showing the configuration of relevant portions of an electrical system of an electronic cassette 40 pertaining to the second embodiment. The electronic cassette 40 shown in FIG. 12 is equipped with a battery remaining capacity detecting unit 65 that detects the battery remaining capacity of the built-in power source unit (battery) 70. The battery remaining capacity of the power source unit 70 detected by the battery remaining amount detecting unit 65 is input to the cassette controller 58 as a battery remaining capacity detection signal. The other configural elements of the electronic cassette 40 shown in FIG. 12 are the same as those of the electronic cassette 40 configuring the radiographic image capturing system 104 pertaining to the first embodiment, so description thereof here will be omitted.

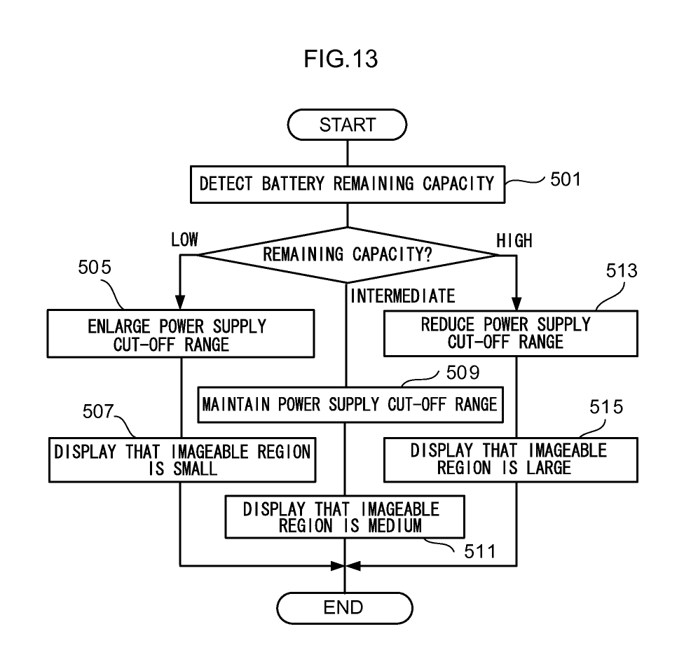

FIG. 13 is a flowchart showing a flow of imaging region enlargement/reduction processing based on battery remaining capacity in the electronic cassette 40 pertaining to the second embodiment. In step 501 of FIG. 13, the battery remaining capacity detecting unit 65 detects the battery remaining capacity of the power source unit 70. In the next step 503, the cassette controller 58 judges to which of “high,” “intermediate,” and “low” the battery remaining capacity of the power source unit 70 detected by the battery remaining capacity detecting unit 65 belongs. Here, when the battery remaining capacity is high, this means, for example, that the terminal voltage of the power source unit 70 exceeds a predetermined threshold value 1 and that the power source unit 70 is fully charged or nearly fully charged. When the battery remaining capacity is low, this means that the terminal voltage of the power source unit 70 is smaller than a predetermined threshold value 2 (which is less than threshold value 1) and that continued use of the electronic cassette 40 cannot be ensured unless the electronic cassette 40 is charged. Further, when the battery remaining capacity is intermediate, this means that the terminal voltage of the power source unit 70 is between the threshold value 1 and the threshold value 2 and that continued use of the electronic cassette 40 for a predetermined number of times, for example, is ensured.

In a case where the battery remaining capacity is low, in step 505 the cassette controller 58 controls in such a way as to reduce the number of the image reading units 120A, 120B, and 120C to be made targets of the cut-off of the power supply from the radiation irradiation detecting unit power source 55A (enlargement of the power supply cut-off range). Specifically, the cassette controller 58 switches on the switch 130A of the image generating unit 54 and switches off the other switches 130B and 130C. Because of this, power is supplied only to the image reading unit 120A corresponding to the imaging region 20A of the three imaging regions 20A, 20B, and 20C (see FIG. 5 and FIG. 8) of the radiation detector 20. Then, in step 507, the cassette controller 58 visibly displays on the console 110 the fact that only the imaging region 20A is usable.

Conversely from the case described above, in a case where the battery remaining capacity is high or intermediate, the cassette controller 58 increases the number of the image reading units to which power is supplied to thereby enlarge the imaging region in accordance with the battery remaining capacity (reduction of the power supply cut-off range). In a case where the battery remaining capacity is high, in step 513 the cassette controller 58 switches on all the switches 130A, 130B, and 130C of the image generating unit 54. Then, in step 515, the cassette controller 58 visibly displays on the console 110 that face that all the imaging regions 20A, 20B, and 20C of the radiation detector 20 can be used for imaging. In a case where the battery remaining capacity is intermediate, in step 509 the cassette controller 58 supplies power to the image reading units corresponding to two regions of the imaging regions 20A, 20B, and 20C. Then, in step 511 the cassette controller 58 visibly displays on the console 110 the usable regions.

The display of the imagable range is not limited to the above and may also be the right half or the left half of the radiation detector 20.

In this way, in the electronic cassette 40 pertaining to the second embodiment, the cassette controller 58 enlarges or reduces, in a stepwise manner in accordance with the battery remaining capacity of the power source unit 70, the image reading units to which power is supplied. That is, the cassette controller 58 enlarges the range of the image reading units to which power is supplied as the battery remaining capacity becomes lower and reduces the range of the image reading units to which power is supplied as the battery recovers. In other words, the cassette controller 58 restricts the imagable range (region) of the radiation detector 20 in accordance with the battery remaining capacity beforehand. By doing so, in the wireless electronic cassette 40, it becomes possible to capture a radiographic image in an imaging region, of the imaging regions divided in rectangular strip shapes, in a range commensurate with the battery remaining capacity, and power saving in the wireless electronic cassette 40 can be efficiently carried out.

Moreover, when the cassette controller 58 enlarges or reduces, in a stepwise manner in accordance with the battery remaining capacity, the image reading units to which power is supplied, in accompaniment therewith the cassette controller 58 visibly displays on the console 110 the imagable region in the radiation detector 20, whereby a technologist or the like can smoothly and quickly perform the work of capturing a radiographic image.

### Third Embodiment

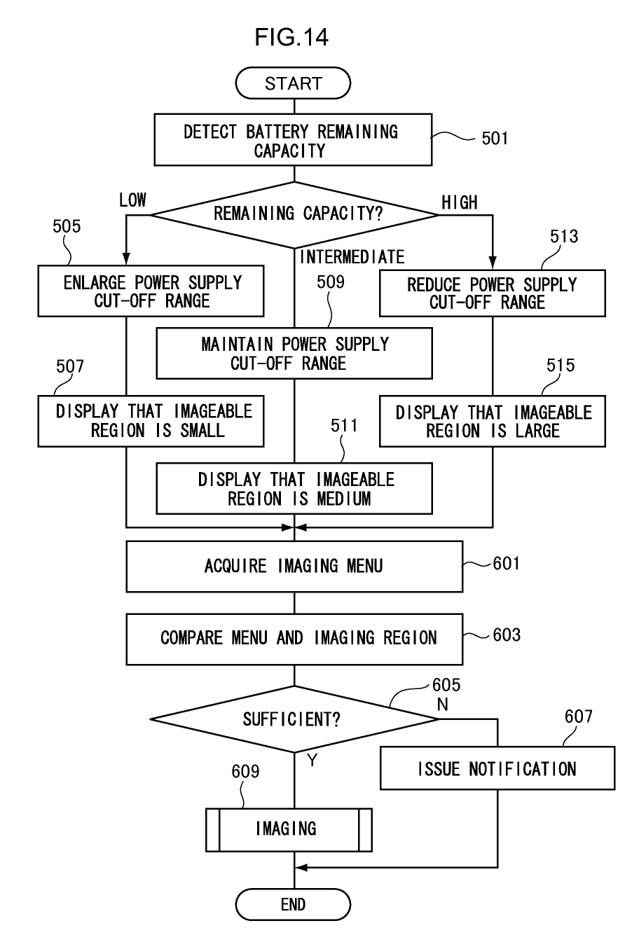

A third embodiment of the present invention will be described. In the third embodiment, the cassette controller 58 performs processing that takes into consideration an imaging menu and the imagable region in addition to the processing resulting from the second embodiment. FIG. 14 is a flowchart showing a processing sequence in the third embodiment. In FIG. 14, the same reference numerals are given to processing steps that are the same as the processing steps in FIG. 13, and description of those processing steps will be omitted.

In step 601 of FIG. 14, the cassette controller 58 acquires an imaging menu. For example, the cassette controller 58 acquires, as the imaging menu, a specific imaging site of a subject, such as a hand, an arm, or a leg. In step 603, the cassette controller 58 compares the imaging menu acquired in step 601 and the imagable range based on the battery remaining capacity of the power source unit 70 detected in step 503. Then, in step 605, the cassette controller 58 judges whether or not the imaging site shown in the imaging menu can be sufficiently captured in the imagable range. If the imagable range is sufficient, the cassette controller 58 enters imaging processing as is (step 609). However, in a case where the imagable range is narrow with respect to the imaging site, the cassette controller 58 issues a notification by displaying that fact on the console 110 or the like.

In this way, by judging the suitability of the imagable range with respect to the imaging menu and issuing a notification of the result, the cassette controller 58 can immediately judge whether or not imaging is possible in a case where, for example, the imaging site is too much larger than the imagable range, so by prompting the technologist to exchange the cassette, needless power consumption can be suppressed as a result. Further, trouble in which only imaging in a small region (e.g., ¼ size) was able to be performed even though the desire was for imaging with a large size (e.g., ½ size) can be prevented.

The present invention has been described above using embodiments, but the technical scope of the present invention is not limited to the scope described in the embodiments. Various changes or improvements can be made to the embodiments without departing from the gist of the invention, and the technical scope of the present invention also includes embodiments to which such changes or improvements have been made.

Further, the above embodiments are not intended to limit the inventions pertaining to the claims, and it is not the case that all combinations of features described in the embodiments are essential to the solution of the present invention. The above embodiments include inventions of a variety of stages, and a variety of inventions can be extracted by appropriate combinations of the plural configural requirements disclosed. Even when several configural requirements are omitted from all the configural requirements disclosed in the embodiment, configurations from which those several configural requirements have been omitted can also be extracted as inventions as long as effects are obtained.

For example, the placement of the radiation detecting pixels in the individual regions of the imaging region is not limited to the example shown in FIG. 5, and there are no particular restrictions on the positions in which the radiation detecting pixels are placed. In the above embodiments, some of the pixels 32 disposed in the radiation detector 20 are used as the radiation detecting pixels 32A, so it goes without saying that it is preferred that the radiation detecting pixels 32A adjacent to each other be spaced far enough apart from each other so that defective pixel correction processing can be implemented.

Further, in the above embodiments, a case was described where the radiation detecting pixels 32A are used for detecting the start of irradiation of the radiation and the end of irradiation of the radiation. However, the present invention is not limited to this and may also be given a configuration where the radiation detecting pixels 32A are used to determine the irradiated amount of the radiation and detect the timing of the proper irradiated amount by integrating or cumulatively adding the outputs of the variable gain pre-amps 92 or to detect the exposure rate per unit time of the radiation that is dependent on the tube voltage and the tube current of the radiation source for exposure management in fluoroscopy or the like by determining the maximum value of the outputs of the variable gain pre-amps 92.

Further, in the above embodiments, a case was described where the radiation detecting pixels 32A lined up in the row direction in the radiation detector 20 are connected to shared direct read-out lines 38. However, the present invention is not limited to this and may also be given a configuration where all the radiation detecting pixels 32A are separately connected to different direct read-out lines 38.

Further, in the above embodiments, a case was described where the power supply to the radiation irradiation detecting unit 55 was started at the timing when the input of the initial data ended. However, the present invention is not limited to this and may also be given a configuration where, for example, a switch that is push-operated by a radiographer or the like when emitting the radiation is disposed and the power supply to the radiation irradiation detecting unit 55 is started at the timing when that switch is push-operated.

Further, in the above embodiments, a case was described where the power supply to the radiation irradiation detecting unit 55 was stopped when performing image read-out. However, the present invention is not limited to this and may also be given a configuration where, for example, power is supplied to the radiation irradiation detecting unit 55 also when performing image read-out and the power supply to the image generating unit 54 is stopped when detecting the start of irradiation of the radiation.

Further, in the above embodiments, a case was described where the radiation generator 120 performs emission of the radiation with the radiation source 121 when the exposure conditions are set from the console 110 and the start of exposure has been instructed. However, the present invention is not limited to this and may also be given a configuration where, for example, a switch that is operated by a radiographer or the like when causing the radiation generator 120 to start the emission of the radiation and when causing the radiation generator 120 to end the emission is disposed and control is performed by the radiation source controller 122 of the radiation generator 120 so as to start and end the emission of the radiation in accordance with operations with respect to the switch.

Further, in the above embodiments, a case was described where the power supply to the image generating unit 54 was started immediately before reading out the image data. However, the present invention is not limited to this and may also be given a configuration where, for example, the power supply to the image generating unit 54 is started at either timing of after it has been detected that irradiation of the radiation has been started, such as immediately after it has been detected that irradiation of the radiation has been started, and before the read-out of the image data is started.

Further, in the above embodiments, a case was described where the present invention is applied to a configuration that controls the power supply to the image generating unit 54 and the radiation irradiation detecting unit 55. However, the present invention is not limited to this and, for example, may also be applied to a configuration that controls the power supply of the bias voltage to the radiation detecting pixels 32A and the radiographic image acquiring pixels 32B or may also be applied to a configuration that controls both the power supply to the image generating unit 54 and the radiation irradiation detecting unit 55 and the power supply of the bias voltage to the radiation detecting pixels 32A and the radiographic image acquiring pixels 32B.

Further, in the above embodiments, a case was described where some of the pixels 32 disposed in the radiation detector 20 are used as the radiation detecting pixels 32A corresponding to the radiation detecting elements of the present invention. However, the present invention is not limited to this and may also, for example, be given a configuration where, as disclosed in Japanese Patent No. 4,217,443 as an example, the radiation detecting pixels 32A are layered in the radiation detector 20 as a separate layer from the pixels 32 or a configuration where, as disclosed in Japanese Patent No. 4,217,506 as an example, radiation detecting elements that act in the same way as the radiation detecting pixels 32A are disposed separately from the pixels 32. In this case, defective pixels do not arise, so the quality of the radiographic image can be improved compared to the above embodiments.

Further, in the above embodiments, a case was described where the radiation detecting pixels 32A are used as dedicated pixels that detect radiation, but the present invention is not limited to this and may also be given a configuration where the radiation detecting pixels 32A double as the radiographic image acquiring pixels 32B. As an example configuration in this case, as disclosed in JP-A No. 2009-219538 as an example, a configuration where the state of irradiation of the radiation is detected on the basis of a change in the bias voltage flowing to each pixel is exemplified.

Further, in the above embodiments, a case was described where the radiation detecting elements of the present invention are disposed on the TFT substrate 30. However, the present invention is not limited to this and may also be given a configuration where, for example, the radiation detecting elements are disposed on a substrate differing from the TFT substrate 30 inside the electronic cassette 40 or a configuration where the radiation detecting elements are disposed separate from the electronic cassette 40 in such a way as to be superposed on side on which the radiation is made incident or the opposite side of the side on which the radiation is made incident. In this case, the same effects as those in the above embodiments can be achieved.

Further, in the above embodiments, a case was described where the sensor portions 13 are configured to include the organic photoelectric conversion material in which electric charge is generated as a result of receiving the light generated by the scintillator 8. However, the present invention is not limited to this and may also be given a configuration that applies sensor portions configured to not include the organic photoelectric conversion material as the sensor portions 13.

Further, in the above embodiments, a case was described where the radiation detector 20 and the case 42 accommodating the cassette controller 58 and the power source unit 70 are placed inside the casing 41 of the electronic cassette 40 in such a way as to not coincide, but the present invention is not limited to this. For example, the cassette controller 58 and the power source unit 70 may also be placed in such a way as to coincide with the radiation detector 20.

Further, in the above embodiments, a case was described where communication is performed wirelessly between the electronic cassette 40 and the console 110 and between the radiation generator 120 and the console 110. However, the present invention is not limited to this and may also be given a configuration where, for example, communication between at least one of these is performed via wires.

Further, in the above embodiments, a case was described where X-rays are irradiated as the radiation, but the present invention is not limited to this and may also be given a configuration where another form of radiation such as gamma rays is irradiated.

In addition, the configuration of the electronic cassette 40 and the configuration of the imaging system 104 described in the above embodiments are examples, and it goes without saying that unnecessary sections can be omitted therefrom, new sections can be added thereto, and states of connection and so forth can be changed without departing from the gist of the present invention.

Further, the configuration of the initial data described in the above embodiments is also an example, and it goes without saying that unnecessary data can be omitted therefrom and new data can be added thereto without departing from the gist of the present invention.

Further, the flows of processing by the various programs described in the above embodiments are also examples, and it goes without saying that unnecessary steps can be omitted therefrom, new steps can be added thereto, and the processing order can be switched around without departing from the gist of the present invention.

What is claimed is:

1. A radiographic image detecting device comprising:
a radiation detecting panel in which plural radiation detecting elements that generate electric charges in response to a dose of irradiated radiation are two-dimensionally arrayed;
plural image acquiring units that read out the electric charges stored in the radiation detecting elements, each of the image acquiring units belonging to one of plural blocks into which the plural radiation detecting elements are divided, to thereby acquire image data;
a power source that supplies driving power to the image acquiring units corresponding to each of the plural blocks; and
a controller that controls in such a way as to cut off the supply of power from the power source to the image acquiring units corresponding to the blocks in accordance with a predetermined condition.

2. The radiographic image detecting device according to claim 1, further comprising a radiation detecting unit that detects a region of the radiation detecting panel to which the radiation is not irradiated, wherein the controller takes as a condition the irradiation not being detected by the radiation detecting unit and controls in such a way as to cut off the supply of power from the power source to the image acquiring unit belonging to the block corresponding to the region in which the irradiation is not detected.

3. The radiographic image detecting device according to claim 1, further comprising a battery remaining capacity detecting unit that detects the battery remaining capacity of a battery installed in the radiographic image detecting device, wherein the controller takes as a condition the battery remaining capacity detected by the battery remaining capacity detecting unit, decreases a target range of the plural image acquiring units to which the power supply is cut off as the battery remaining capacity becomes higher and enlarges the target range of the plural image acquiring units to which the power supply is cut off as the battery remaining capacity becomes lower.

4. The radiographic image detecting device according to claim 1, wherein the controller enlarges the region of the blocks that detect the irradiated radiation by decreasing the target range of the plural image acquiring units to which the power supply is cut off and reduces the region of the blocks that detect the irradiated radiation by enlarging the target range of the plural image acquiring units to which the power supply is cut off.

5. The radiographic image detecting device according to claim 2, wherein the controller enlarges the region of the blocks that detect the irradiated radiation by decreasing the target range of the plural image acquiring units to which the power supply is cut off and reduces the region of the blocks that detect the irradiated radiation by enlarging the target range of the plural image acquiring units to which the power supply is cut off.

6. The radiographic image detecting device according to claim 3, wherein the controller enlarges the region of the blocks that detect the irradiated radiation by decreasing the target range of the plural image acquiring units to which the power supply is cut off and reduces the region of the blocks that detect the irradiated radiation by enlarging the target range of the plural image acquiring units to which the power supply is cut off.

7. The radiographic image detecting device according to claim 1, further comprising a presenting unit that presents the region of the blocks to which the supply of the power has been cut off.

8. The radiographic image detecting device according to claim 2, further comprising a presenting unit that presents the region of the blocks to which the supply of the power has been cut off.

9. The radiographic image detecting device according to claim 3, further comprising a presenting unit that presents the region of the blocks to which the supply of the power has been cut off.

10. The radiographic image detecting device according to claim 1, further comprising
a comparing unit that compares the region of the blocks corresponding to the image acquiring units to which the power source has been supplied and a region required for imaging an imaging target site of a radiographic image and
a notifying unit that issues a predetermined notification in a case where the region of the blocks is smaller than the region required for imaging.

11. The radiographic image detecting device according to claim 2, further comprising
a comparing unit that compares the region of the blocks corresponding to the image acquiring units to which the power source has been supplied and a region required for imaging an imaging target site of a radiographic image and
a notifying unit that issues a predetermined notification in a case where the region of the blocks is smaller than the region required for imaging.

12. The radiographic image detecting device according to claim 3, further comprising
a comparing unit that compares the region of the blocks corresponding to the image acquiring units to which the power source has been supplied and a region required for imaging an imaging target site of a radiographic image and
a notifying unit that issues a predetermined notification in a case where the region of the blocks is smaller than the region required for imaging.

13. The radiographic image detecting device according to claim 1, wherein
the radiation detecting elements have semiconductor films that receive the irradiation and generate electric charges,
the electric charges are stored in storage capacitors disposed in each of the plural pixels, and
the electric charges that have been stored in the storage capacitors are read out by the switch elements.

14. The radiographic image detecting device according to claim 2, wherein
the radiation detecting elements have semiconductor films that receive the irradiation and generate electric charges,
the electric charges are stored in storage capacitors disposed in each of the plural pixels, and
the electric charges that have been stored in the storage capacitors are read out by the switch elements.

15. The radiographic image detecting device according to claim 3, wherein
the radiation detecting elements have semiconductor films that receive the irradiation and generate electric charges,
the electric charges are stored in storage capacitors disposed in each of the plural pixels, and
the electric charges that have been stored in the storage capacitors are read out by the switch elements.

16. The radiographic image detecting device according to claim 1, wherein the radiation detecting elements have a scintillator that converts the irradiated radiation into visible light, and after the visible light into which the irradiated radiation has been converted is converted into electric charges in a semiconductor layer, electric signals corresponding to the electric charges are outputted by the switch elements.

17. The radiographic image detecting device according to claim 2, wherein the radiation detecting elements have a scintillator that converts the irradiated radiation into visible light, and after the visible light into which the irradiated radiation has been converted is converted into electric charges in a semiconductor layer, electric signals corresponding to the electric charges are outputted by the switch elements.

18. The radiographic image detecting device according to claim 3, wherein the radiation detecting elements have a scintillator that converts the irradiated radiation into visible light, and after the visible light into which the irradiated radiation has been converted is converted into electric charges in a semiconductor layer, electric signals corresponding to the electric charges are outputted by the switch elements.

19. A radiographic image detecting method comprising:
dividing, into plural blocks, plural radiation detecting elements that are two-dimensionally arrayed in a radiation detecting panel and generate electric charges in response to a dose of irradiated radiation and reading out, with image acquiring units, the electric charges stored in the radiation detecting elements belonging to each of the plural blocks to thereby acquire image data;
supplying power for driving to the image acquiring units corresponding to each of the plural blocks;
detecting a region of the radiation detecting panel to which the radiation is not irradiated; and
controlling in such a way as to cut off the supply of power from the power source to the image acquiring units belonging to the blocks corresponding to the region in which irradiation is not detected.

20. A non-transitory computer-readable storage medium that stores a program that causes a radiographic image detecting device to execute processing, the radiographic image detecting device including a radiation detecting panel in which plural radiation detecting elements that generate electric charges in response to a dose of irradiated radiation are two-dimensionally arrayed, plural image acquiring units that read out the electric charges stored in the radiation detecting elements belonging to each of plural blocks into which the plural radiation detecting elements are divided to thereby acquire image data, and a power source that supplies power for driving to the image acquiring units corresponding to each of the plural blocks, the processing comprising:
detecting whether or not the radiation is irradiated to the radiation detecting panel, and
controlling in such a way as to cut off the supply of power from the power source with respect to the blocks corresponding to a region in which irradiation is not detected by the radiation detecting unit.
